(19) United States
(12) Patent Application Publication
(10) Pub. No.: US 2003/0085357 A1
(43) Pub. Date: May 8, 2003

(54) Process and installation for the measurement of a flow of ionizing radiations and the absorbed dose

(75) Inventors: Anne Elisabeth Kazandjian, Chennevieres Sur Marne (FR); Claude Teissier, Lingolsheim (FR)

Correspondence Address: YOUNG & THOMPSON, 745 SOUTH 23RD STREET 2ND FLOOR, ARLINGTON, VA, 22202

(73) Assignee: EURORAD 2-6 (SOCIETE ANONYME), STRASBOURG CEDEX (FR)

(21) Appl. No.: 10/279,049

(22) Filed: Oct. 24, 2002

(30) Foreign Application Priority Data
Nov. 2, 2001 (FR) 0114233

(51) Int. Cl. G01T 1/24

(52) U.S. Cl. 250/370.07; 250/370.06; 250/370.13

(57) ABSTRACT

The present invention relates to a process and installation for simultaneously measuring the flux of ionizing radiation, of an energy greater than several kVe and the dose of radiation received by a body exposed to this radiation.

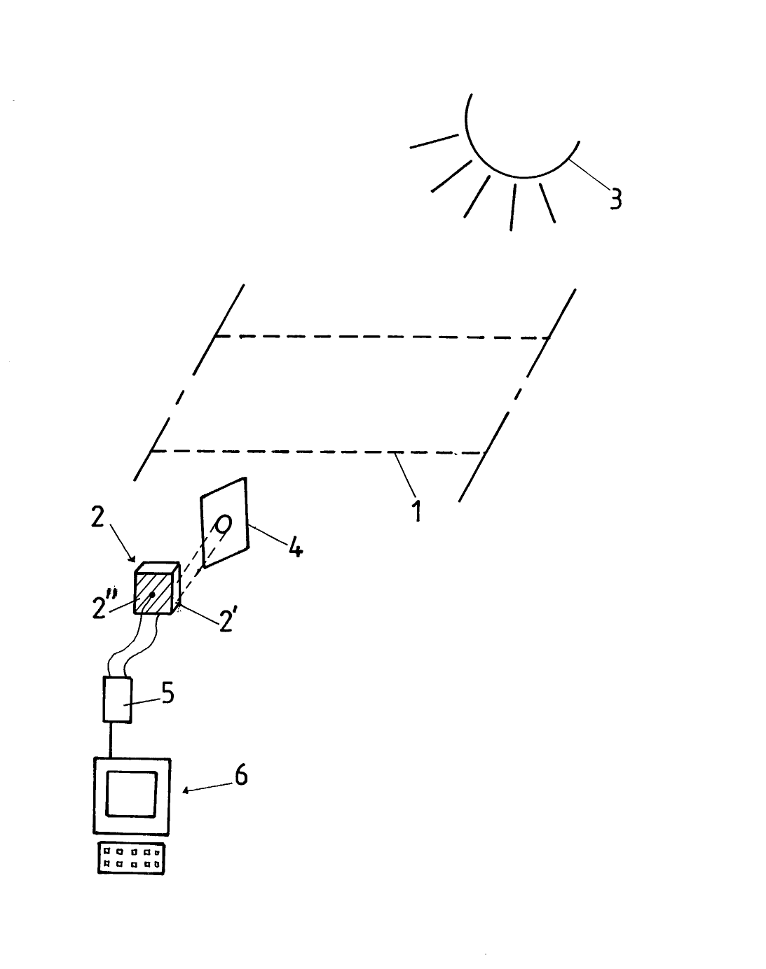

Process characterized in that it consists, first of all, in subjecting a semiconductor detector (2) operating in impulsional mode to the radiation to be applied to said body (1), in recording a first energy spectrum of the instant radiation at said detector (2), then in emplacing said body (1) between the radiation source (3) and the detector (2), in then subjecting said body (1) to said radiation for the predetermined duration and recording a second energy spectrum of the radiation incident at said detector (2), in computing a differential energy spectrum from said first and second spectra and segmenting it at energy intervals, and, finally, determining, on the one hand, the total radiation dose absorbed by the body (1) by summation of the elemental doses calculated for each of the mentioned intervals of said differential spectrum and, on the other hand, the flux emitted from the first spectrum of recorded energy.

The present invention relates to the field of measuring ionizing radiations, in particular radiations emitted by x-ray tubes.

It has for its object a process and installation for the simultaneous measurement of the flow of ionizing particles directly and indirectly, as well as the absorbed dose, resulting from the action of this radiation on a body, particularly a living organism. These measurements are, according to the invention, preferably carried out as a function of the energy of photons.

The present invention relates generally to the simultaneous determination of the flow of particular or photonic radiations and the absorbed dose, as a function of the energy of the ionizing radiations, at all energies. It is however described more particularly, but not in a limiting manner, with respect to x-rays.

Thus, these latter are at present used to conduct medical examinations, in the course of which the patients, as well as the operating personnel, are subjected to high doses of radiation of which there is occasion to know the characteristics and value in a reliable and complete manner.

Thus, the French, European and even international standards require the measurements of certain parameters of the x-ray installations, particularly those used for medical investigations (see on this subject: S. Green et al., Applied Radiation and Isotopes, 50, 1999, 137-152).

In particular, three fundamental parameters must necessarily be periodically verified, ideally for each examination. These are:

the high voltage applied to the tube that generates x-rays;

the flow of radiation emitted by the tube and falling on the region of the observer;

the dose of x radiations received by the patient or the personnel present during the medical examination.

At present, different techniques are now used to carry out separately these three types of measurements and to evaluate the values of the parameters, this while using different apparatuses (kVp meter, flux meter, dosimeter), rendering them thus extremely delicate.

Moreover, the dose delivered by the x-rays and the does absorbed by the patient are not generally measured directly, but deduced from the doses absorbed in a material or a different manner by human tissues, which necessarily involves approximations resulting from the differences in the coefficients of absorption.

It is to be remembered that the dose absorbed by the material at one point is defined as being the quotient of the energy given up to a volume of material about this point by the mass of the volume of this material.

Generally speaking, interactions of the indirectly ionizing radiations in the material lead to their attenuation by different phenomena:

the photoelectric effect characterized by the coefficient τ,

the Compton effect coefficient σ,

the coherent diffusion coefficient σ_{coh},

production of pairs of a coefficient K (for the memory in the case of X).

The energy transfer to the material is characterized by a mass coefficient μₖ/ρ=dEₖ/Eρ. Dl, wherein dEₖ equals the sum of the kinetic energies of all the charged particles freed across the thickness of the material dl.

This transferred energy related to the mass of material being called the kerma K, wherein:

K=F μₖ/ρ (F=energy flow) or K=ΔEₖ/Δm

The dose absorbed in the material D is characterized by a mass coefficient of energy μₑₙ/ρ equal to (μₖ/ρ) (1-G), G being the proportion of energy of the charged secondary particles lost by braking radiation.

Thus, D=F.μₑₙ/ρ and, at the electronic equilibrium and if the losses by braking radiation are negligible, D=K.

In the field of x-rays used in medicine (rays created by electrons accelerated by voltages between 30 and 150 kV), it is practically the photoelectric effect alone which leads to the dose absorbed in the material.

However, it is at present difficult to measure exactly the dose delivered by the x-rays and it is necessary to deduce the dose absorbed in the material other than the human body, whilst in the range of energy used for medical examinations by x-rays, responses vary considerably.

Generally, there is used a material in which it is possible to connect the interaction of the radiation to an electrical phenomenon or to a chemical reaction. Among these detection modes, can be cited the ionization of air (measurement of the electric charge collected in a given volume), of a particular gas or of a suitable solid (counting the electrical pulses created by the interactions), the creation of a latent image in an emulsion sensitive to charged particles from the exterior or created within the emulsion, the measurement differing from the energy given to a thermoluminescent material, etc.

However, as all material has its own coefficient of absorption (substantially proportional to the power 4 of its atomic number), the result of the measurement must be corrected if it is desired to obtain a value approaching the value in the human body.

Moreover, as a function of the radiation energy, the response can vary over a wide range (generally overestimated at low energies) according to the value of the photoelectric coefficient.

In general, reference is had to a scale with a radioactive source emitting energy radiation of the order of Mev. It will be easily seen that the value given in a radiation field of low energy will be substantially different, and that the detector will be sensitive to it.

To obtain a value of dose absorbed in living tissues, several conditions are necessary, namely, in particular: to calibrate the detector in the field of radiation characteristic of the emitted energy, filtration of the detector to free it from excessive responses relative to the human body.

Moreover, it should be noted that the emission spectrum of x-rays in a tube is a wide spectrum as to energy, because of this, the biological effects of the different X photons are very different according to said energy. Most of the present installations for measurement do not permit taking full account of this fact, because they operate most often in generated photocurrent, which does not permit distinguishing the effects of the energies involved.

Finally, the detector having been disposed in the examination region of the patient and being opaque to x-rays, it necessarily disturbs the results of the examination to be carried out.

The present invention has for its object to overcome at least certain of the mentioned drawbacks and particularly to permit easy and precise and reliable measurement of the dose absorbed and of the flux emitted with a same measuring device.

To this end, the invention has for its principal object a process for simultaneous measurement of the flow of ionized radiations (typically but not limitingly the energy greater than several keV) and the absorbed dose of the radiations received by the body exposed to these radiations, characterized in that it consists first of all in subjecting a semiconductor detector operating in an impulsional mode to the radiation before being applied to said body during the time provided for exposition of said body and by placing it in the position provided for this latter, in recording a first energy spectrum of the instant radiation in said detector, then in emplacing said body between the source of radiation and the detector, in subjecting said body to said radiation for the predetermined time and in recording a second energy spectrum of the incident radiations in said detector, in computing a differential energy spectrum from said first and second spectra and segmenting it by energy intervals, and, finally, determining on the one hand the dose of total radiation absorbed by the body by summation of the elementary doses calculated for each of the mentioned intervals of said differential spectrum and, on the other hand, the flow emitted from the first spectrum of recorded energy.

Thus, according to the invention, a detector is disposed directly in the intense flow of x-rays. This detector is associated with an electronic device (forming with said detector a measuring installation) which will exploit the signals from the detector and will supply the energy spectrum (number of photons or analogous particles as a function of the energy of the instant radiation beams).

This measurement assembly then will transmit to a memory the distribution of the number of photons or of analogous particles accumulated during a given time as a function of the energy associated with said particles.

More precisely, each elemental dose is calculated as a function of the mean energy values of the energy intervals compartmentalizing the differential spectrum in question, and the energy mass coefficients relative to each of these mean energy values, given the nature of the materials forming the body or the region of the body subjected to said radiation, the energy spectrum being preferably subdivided into 5 to 30 intervals, preferably about 10.

Preferably, the process could also consist in determining, particularly for x-ray radiation, the maximum voltage of the emitting tube forming the source 3 from the first recorded spectrum.

Thus, the invention will permit by two measurements carried out with the same device, determining in a precise manner the values of the three fundamental parameters.

So as to permit an operation of the detector in the impulsional mode (and not as in the prior art in a current mode), permitting the acquisition of an energy spectrum, the flux of radiations incident at the level of said detector should be very greatly reduced.

To do this, it is possible either to authorize only a predetermined portion of the radiations emitted to reach the detector, or to diffuse them on a suitable support.

In the first case (direct arrival), there will be obtained the exact spectrum (to the approximate efficiency corrections) and, in the second case, the diffused spectrum which will permit under precise and known angular observation, to go back to the direct spectrum (Klein-Nishina formula).

Nevertheless, this latter indirect approach requiring a reconstruction of the initial spectrum, before itself being corrected by the curve of efficiency of the detector, will be removed because of too great errors.

Thus, according to a preferred embodiment of the invention, a collimator limiting the instant radiation, is associated with said detector and this latter and said collimator are disposed such that said detector will be directly exposed to the radiation and that the photons or incident particles entering into contact with it essentially at one of its electrodes or in the section, particularly as a function of its structure and its geometry, so as to obtain an absorption as complete as possible of the incident radiation striking the detector.

To promote this latter, the material constituting the detector has a high atomic number, preferably greater than or equal to at least 30, has a prohibited bandwidth of at least 1.1 eV and has a high speed of collection of the photogenerated charges.

Preferably, the constituent material of the detector is selected from the group formed by cadmium telluride (CdTe), cadmium zinc telluride (CdZnTe), silicon (Si), gallium arsenide (GaAs) and mercury iodide (HgI₂).

The process according to the invention resides, as a result, in two identical measurement sequences and in the simple consecutive mathematical operations using the results collected during these two mentioned sequences.

Thus, in the scope of determination of the three mentioned fundamental parameters, in relation to an x-ray examination of a patient, it can be provided that, in the first instance, the detector, associated with suitable electronic and computer means, records the energy spectrum at the place where the patient to be examined will be disposed during the time corresponding to the provided examination.

The spectrum is memorized and the maximum voltage of the x-ray generating tube can be deduced from the maximum energy raised on the memorized spectrum.

During the course of examination, the detector records the new spectrum, which is to say that which corresponds to the transmitted energy spectrum.

Mathematical processing then permits constituting the energy spectrum “difference”, namely the number of photons absorbed by the patient “playing the role of a screen”).

By another processing, this latter spectrum will be cut into “sections”: the number of photons Ni over an interval to be defined dE about a predetermined energy Ei.

The elementary absorbed dose in a section of energy dE from human tissue (to be defined according to the category to be fixed by adjustment: soft tissue, bony tissue, organ . . . ) will be attained like the product of Ei by the coefficient μₑₙ/ρ relative to this energy.

The sum of the elemental doses on the assembly of the differential spectrum will give the dose absorbed by the patient in the course of the examination.

It should be noted that this measurement and this processing constitute the most exact result of the value of the dose (total), because it results directly from the definition of this latter.

The present invention also has for its object an installation for practicing the measurement process described above, characterized in that it comprises, on the one hand, a semiconductor detector operating in an impulsional mode and, on the other hand, means for converting and acquiring measurement signals delivered by the detector, of recording first and second energy spectra during predetermined times of exposition, particularly similar, respectively, in the absence and in the presence of an intermediate absorbent body, of determination of the radiation flux received by said body and computing the dose received by this latter, these means being associated with, or at least in part comprised by, a computer unit controlling at least said measurement process, by means of suitable software.

The present invention will be better understood from the following description, which relates to a preferred embodiment, given by way of non-limiting example, and explained with reference to the accompanying schematic drawing, in which the single FIGURE represents in a schematic manner a measurement installation according to the invention, installed in association with an x-ray examination apparatus (only the generator tube is shown) for a patient (represented partially in broken lines).

As shown in the FIGURE of the accompanying drawing, the measurement installation comprises essentially, on the one hand, a semiconductor detector 2 operating in an impulsional mode and, on the other hand, means 5, 6 for converting and acquiring measurement signals delivered by the detector 2, for registering a first energy spectrum and a second energy spectrum during predetermined times of exposition, particularly similar, respectively, in the absence and presence of an intermediate absorbing body 1, determining the radiation flux received by said body 1 and computing the dose received by this latter, these means being associated with or at least in part comprised by a computer unit 6 controlling at least said measurement process.

So as to permit direct recordation of the energy spectrum, a collimator 4 limiting the quantity of incident radiation, for example the number of photons or electrons, is associated with the detector 2, and this latter and said collimator 4 are positioned such that the incident radiation striking said detector 2 is received by this latter in a thickened region with a high field.

This region has particularly been identified in the document “Spectroscopic performance of newly designed CdTe detectors”, Nuclear Instruments and Methods in Physics Research, A 458 (2001), 233-241, whose content is appropriated in the present application by reference.

This collimator 4, made in a known manner, will permit reducing the intensity of incident radiation and this without alteration, which is to say by limiting the phenomena of diffusion or fluorescent excitation on its walls. This will permit resetting the counting quantity to values compatible with the possibilities of spectroscopic measurement by digital electronics with low noise 5 (carrying out the acquisition and conversion of the detector signals), at present of the order of 500 kHz.

The semiconductor detector 2 correctly collimated will therefore permit recordation thanks to low noise electronics and a multi-channel analyzer (for example mounted on an individual computer or PC), the precise spectra of x-rays falling on the zone at which said detector is placed. This spectrum will eventually be corrected by the efficiency coefficient of the detector 2 as a function of the energy (preliminary calibration in the PC).

According to a preferred embodiment of the invention, the arrangement and positioning of the detector 2 and of the collimator 4 are such that the photons or incident particles enter into contact with it essentially at one of its electrodes 2′ or by the section 2″, particularly as a function of its structure and geometry.

An important factor for carrying out the invention, and particularly its practical application, is the selection of the characteristics and properties of the detector 2 that is used.

Thus, as to the constituent material of this latter, there will be selected for reasons of convenience semiconductor materials operating correctly at ambient temperature.

Other criteria will also be derived by the material to be retained, namely:

having a fairly high atomic number (≧30) to permit high efficiency of detection, so as to limit to the maximum the correction factors for the recorded spectra;

having a prohibited bandwidth sufficient to be able to operate at ambient temperature, namely at least 1.1 eV;

resisting intense radiation flux over its lifetime;

having high speeds of collecting photogenerated charges so as not to lose carriers by recombination or trapping.

In the actual state of the art and of the availability of semiconductors, only the following materials will be considered: cadmium telluride (CdTe), cadmium zinc telluride (“CZT”), silica or gallium arsenide for relatively high energies.

It will be apparent to those skilled in the art that this situation could no doubt develop in the future (for example with HgI₂).

In addition to the constituent material, it may also be desirable to define the best structure possible for the detector 2. Certain criteria should be fulfilled, among which the more important are:

absorbing radiation in the region of maximum sensitivity of the detector, which is to say the region where an intense electrical field prevails;

having an intense electrical field so as to collect very rapidly the photogenerated charges before their recombination and without the appearance of an electrical polarization effect;

having a masking current and a noise level as low as possible to permit recording spectra with good energy resolution;

permitting high resolution spectrometry.

According to the nature of the semiconductor, several technological approaches will be possible. In the case of CdTe or CZT, there will be preferred the three following structures for the detector 2:

flat structure irradiated either by one of the flat electrodes (that where the greatest electrical field prevails), or by the slice, perpendicularly or at a certain angle;

hemispherical structure or so-called “U” shape (not shown), in which the field will be logarithmical adjacent the collecting electrode, hence very intense and ensuring because of this a collection of the charges which is both great and rapid, leading to good efficiency of detection and good energy resolution;

so-called “pixilated” structure (not shown), permitting having an electrical field, and also very favorable to high efficiency and energy resolution.

From spectra established by means of detector 2 and means 5, 6, it is in particular possible to extract three parameters which interest principally the medical field, namely:

the maximum voltage of the radiation tube (kVp) which will be the intersection of the energy spectrum recorded for zero flux (flux curve as a function of energy multiplied by the coefficient connecting the voltage to the X energy);

the maximum energy of the x-rays, read directly from the recorded spectrum;

the number of photons with their energy.

From these data can be directly known the dose of the radiation arriving at the region where the detector 2 is located.

Thus, at present, by using the conventional apparatus, this dose is difficult to measure because of the very great intensity of the flux, such that the measurement of the photogenerated currents does not permit rising to the energy of the X photons which have generated them.

In the case of the invention, the energy spectrum recorded in the memory of the computer 6 could be decomposed into certain number of energy domains (their number will depend on the desired position of measurements), generally about 10 zones will be ordinarily sufficient, at least for conventional x-ray equipment.

From the known number of photons of energy falling on the patient 1, it is possible, by using the “quality factors” connected to the biological effects, known from radiation on tissues of the human body in the region of interest, to calculate an equivalent to the dose received by adding together the different selected zones.

It will even be possible to refine the measurements of these equivalents of doses according to the organs under inspection, because it will be possible to select each time the coefficient of conversion of the flow of photons into the dosage (this is not the same in the lungs and in the bones, for example).

It should be noted that the process described above essentially for measurements of x-ray doses, can be extended to other sources of intense radiation or not, so that it will be possible to obtain an operation in impulsional mode for counting radiation.

Of course, the invention is not limited to the embodiment described and shown in the accompanying drawing. Modifications remain possible, particularly as to the construction of the various elements or by substitution of technical equivalents, without thereby departing from the scope of protection of the invenetion.

1. Process for simultaneously measuring the flux of ionizing radiation and the absorbed dose of radiation received by a body exposed to this radiation, characterized in that it consists first in subjecting a semiconductor detector (2) operating in impulsional mode to the radiation to be applied to said body (1) for the time provided for exposure of said body (2) and in positioning at the place provided for this latter, in recording a first energy spectrum of the incident radiation at said detector (2), then in emplacing said body (1) between the source (3) of radiation and the detector (2), then subjecting said body (1) to said radiation for the predetermined definition and recording a second energy spectrum of the radiation incident at said detector (2), computing a differential energy spectrum from said first and second spectra and segmenting at energy intervals, and, finally, determining, on the one hand, the total dose of radiation absorbed by the body (1) by summation of the elemental doses computed for each of the mentioned intervals of said differential spectrum and, on the other hand, the flux emitted from the first spectrum of recorded energy.

2. Process according to claim 1, characterized in that each elemental dose is computed as a function of the values of mean energy of the energy intervals making up the compartments of the differential spectrum concerned and the mass coefficients of energy relative to each of these mean energy values, given the nature of the materials forming the body (1) or the region of the body (1) subjected to said radiation, the energy spectrum being preferably subdivided into 5 to 30 intervals, preferably about 10.

3. Process according to any one of claims 1 and 2, characterized in that it consists in determining, particularly for an x-ray radiation, the maximum voltage of the emitting tube forming the source (3) from the first recorded spectrum.

4. Process according to any one of claims 1 to 3, characterized in that a collimator (4) limiting the incident radiation is associated with said detector (2) and in that this latter and said collimator (4) are disposed such that said detector (2) will be directly exposed to said radiation and that the photons or incident particles enter into contact with it essentially at the level of one of its electrodes (2′) or by the section (2″), particularly as a function of its structure and geometry.

5. Process according to any one of claims 1 to 4, characterized in that the material constituting the detector (2) has a high atomic number, preferably greater than or equal to at least 30, has a prohibited bandwidth of at least 1.1 eV and has a high speed of collection of the photogenerated charges.

6. Process according to claim 5, characterized in that the material constituting the detector (2) is selected from the group formed by cadmium telluride (CdTe), cadmium zinc telluride (CdZnTe), silicon (Si), gallium arsenide (GaAs) and mercury iodide (HgI₂).

7. Installation for practicing the measurement process according to any one of claims 1 to 6, characterized in that it comprises, on the one hand, a semiconductor detector (2) operating in impulsional mode and, on the other hand, means (5, 6) for conversion and acquisition of the measurement signals delivered by the detector (2), of recording a first and second energy spectrum for predetermined durations of exposure, particularly similar, respectively in the absence and in the presence of an intermediate absorbent body (1), determination of the radiation flux received by said body (1) and computing the dose received by this latter, these means being associated with, or at least in part comprised by, a computer unit (6) controlling at least said measurement process.

8. Installation according to claim 7, characterized in that a collimator (4) limiting the quantity of incident radiation, for example the number of photons or electrons, is associated with the detector (2) and in that this latter and said collimator (4) are positioned such that the instant radiation striking said detector (2) is received by this latter in a thick region with a high field.

9. Installation according to claim 8, characterized in that the arrangement and positioning of the detector (2) and of the collimator (4) are such that the photons or incident particles enter into contact with it essentially at one of its electrodes (2′) or by the section (2″), particularly as a function of its structure and geometry.

10. Installation according to any one of claims 7 to 10, characterized in that the material constituting the detector (2) has a high atomic number, preferably greater than or equal to at least 30, has a prohibited bandwidth of at least 1.1 eV and has a high speed of collection of the photogenerated charges.

11. Installation according to claim 10, characterized in that the constituent material of the detector (2) is selected by the group formed by cadmium telluride (CdTe), cadmium zinc telluride (CdZnTe), silicon (Si), gallium arsenide (GaAs) and mercury iodide (HgI₂).

12. Installation according to any one of claims 7 to 11, characterized in that the detector (2) has a structure and a configuration selected from the group formed by a flat structure, a hemispherical structure and a pixilated structure.
